(19) United States
(12) Patent Application Publication
(10) Pub. No.: US 2008/0175976 A1
(43) Pub. Date: Jul. 24, 2008

(54) Gelatin Production System

(76) Inventors: Peter M. Bernegger, West Point, MS (US); David Cooper, Hemet, CA (US)

Correspondence Address: WILSON DANIEL SWAYZE, JR., 3804 CLEARWATER CT., PLANO, TX, 75025, US

(21) Appl. No.: 11/624,328

(22) Filed: Jan. 18, 2007

(51) Int. Cl. A23L 1/325

(52) U.S. Cl. 426/643

(57) ABSTRACT

Process for the preparation of gelatin from fish parts includes the steps of washing the fish parts with an aqueous solution of a calcium hydroxide hydrate and ice to remove blood from the fish parts, treating the washed skins with an acid, and extracting gelatin from the fish skins at a temperature approximately between 100 Fahrenheit to 170 Fahrenheit and at an acidic pH approximately between pH 1.5 to pH 5.5.

### FIELD OF THE INVENTION

The invention relates to a process for the preparation of fish gelatin and fish collagen from fish parts.

### BACKGROUND OF THE INVENTION

Gelatin is a protein of animal origin which has been known for a very long time and has numerous applications in the food, pharmaceutical, photographic and technical sectors.

It is widespread in animal tissues and organs, such as skin and bones, in the form of its natural precursor, collagen.

Gelatin is obtained industrially from the bones and skins of cattle and pigs, collected from abattoirs.

In both the United States and Europe, beef consumption has been decreasing for several years, gradually reducing the supply of bones and skins originating from this source. This phenomenon has been exacerbated in recent years by the bovine spongiform encephalopathy crisis and the resulting regulations.

As far as gelatins of porcine origin are concerned, their development is being restricted by the discovery of new outlets for the starting material for example pork scratchings and aperitif snacks and by religious considerations forbidding their use in certain countries.

It is therefore particularly important to look for other starting materials which can be used for the manufacture of gelatin.

It is known that fish skin, scales and bones also contain collagen similar to that found in mammals.

Patent GB 235,635 relates to the manufacture of fish glues, gelatins and meals from by-products of marine origin. This principally involves treatment of these by-products with alkali, followed by treatment with sulfurous acid and washing with water to remove the volatile bases responsible for the fishy odor. However, there is no description of the by-products used, the extraction conditions or the characteristics of the gelatins obtained.

For several years, to respond to consumer demand for high-quality fresh products, especially fish fillets, the fishing and canning industry has developed the filleting of fish as soon as they were caught or on land after the frozen fish had been defrosted. This results in the availability of a certain amount of fishing byproducts, particularly fish parts and skins, which can potentially be processed to gelatin.

This has been done especially by NORLAND PRODUCTS, which, since 1985, has been producing aqueous solutions of fish gelatin by the acid extraction of cod skins. However, the corresponding gelatins do not qualify as gelling under the customary conditions for measurement of the gelling strength of gelatins (6.67% gelatin solution kept at 10.degree. C. for 17 h according to Bloom's method described in “The Science and Technology of Gelatin”, 1977, A. G. WARD and A. COURTS Eds., Academic Press, p.

507) and remain liquid in solution even when the gelatin concentration is as high as 45%.

Other processes have been developed for improving the quality of the product obtained from fish skins. The process of patent EP 0436266 comprises a step involving treatment with dilute bases, followed by steps involving washing and treatments with different acids. In addition, the gelatin is extracted at neutral pH at a temperature preferably of between 40 and 50 degree. C.

More recently, patent U.S. Pat. No. 5,484,888 reported a process for the preparation of gelatin from kosher fish skins, i.e. skins of fish with scales and fins.

The steps of the process described in said patent take place in a totally alkaline medium, the first step consisting in soaking the skins in an alkaline solution for 3 to 60 days. The extraction is also carried out at an alkaline pH, preferably at a pH equal to 10, and at a temperature of between 45 and 55 degree. C. Finally, in said patent, tuna skins are considered to be unsuitable for the manufacture of gelatin because of the boiling pretreatment to which they are subjected.

U.S. Pat. No. 6,368,656 to Lefebvre relates to a process for the preparation of fish gelatin from fresh or defrosted raw fish skins, which includes the steps of washing of the skins with an aqueous solution, of an oxidizing agent, treatment with acid and hot extraction at an acidic pH.

Most processes to extract fish gelatin from fish wastes (which includes skins, heads and frames) start with raw material which is wet. Furthermore, most processes take a long time to execute the entire processing cycle from the raw material and entering the plant to the finished product which may be either a concentrated liquid gelatin or a dry gelatin. Other processes do not use chemicals to inactivate the natural enzymes that degrade or destroy the gelatin and lower the yield of the gelatin from the wet fish feed material. Once the live fish has been killed, natural enzymes within the fish start to degrade the gelatin. Consequently, it is necessary to process the fish waste as soon as possible or inactivate the enzymes with a chemical that will not degrade the gelatin further. Some types of fish, notably catfish have not produced gelatins of high-quality and have not been sought out as feedstock for gelatin processing. Furthermore, previously described products generate objectionable fish odor in the gelatin.

### SUMMARY OF THE INVENTION

The present invention therefore relates to an acid process for the preparation of high-quality gelling fish gelatin from fish parts, which comprises steps involving washing of the skins with water, treatment with acid and hot extraction at acid pH.

The starting material consists of fish parts obtained in large quantities when the fish is processed raw.

This is especially the case for tuna in brin, but also for other fish such as sole, tilapia and catfish, in particular the freshwater species Ictalurus punctatus commonly called channel catfish, whose raw fillets are marketed in large quantities.

According to one preferred embodiment, the fish skins originate from fish with scales and fins, for example tuna, tilapia, carp, Nile perch, salmon, sole, especially tropical sole, pollack, hake, mackerel or other similar fish.

According to another embodiment of the invention, the fish skins originate from fish without scales, for example catfish, in particular the freshwater species Ictalurus punctatus commonly called channel catfish, or African sea catfish or North African catfish.

The invention provides a processing method to produce finished gelatin products in a short period of time without suffering a loss in yield. This quick processing method allows for reduced time periods in almost all steps to reach a finished gelatin product. The present invention requires a fewer number of employees, less equipment, less energy, reduced processing per square footage, fewer chemicals and a lower amount of chemicals needed per pound of raw material processed. The amount of waste water is comparatively less.

The present invention reduces the pre-extraction preparation time and the purification steps and additionally has a reduced preparation time period. The extraction step uses an acid based formula to reduce the time required. It is advantageous to use a particular type of acid and concentration level that achieves the separation of the triple helix of the collagen but does not destroy the long molecular chains. Due to the type of acid used, the extraction formula and the temperature held during extraction, fewer chemicals are required.

The present invention allows for the separation of higher gel strength of the gelatin called the Bloom strength. The present invention also removes fish oil from the gelatin without the use of a centrifuge.

### BRIEF DESCRIPTION OF THE INVENTION

The invention may be understood by reference to the following description taken in conjunction with the accompanying drawings, in which, like reference numerals identify like elements, and in which:

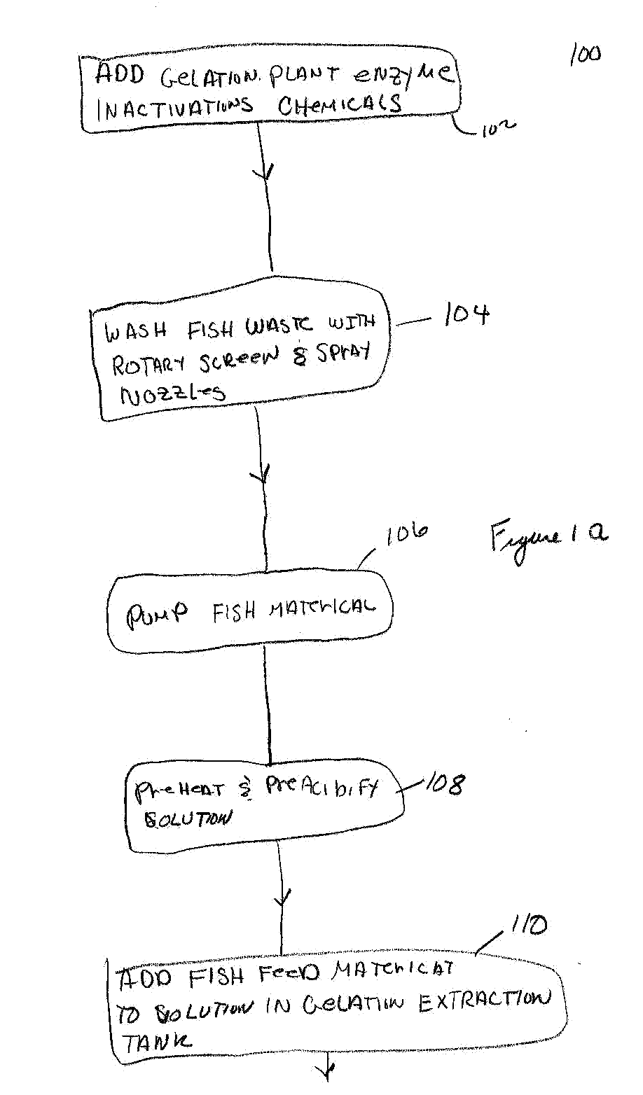

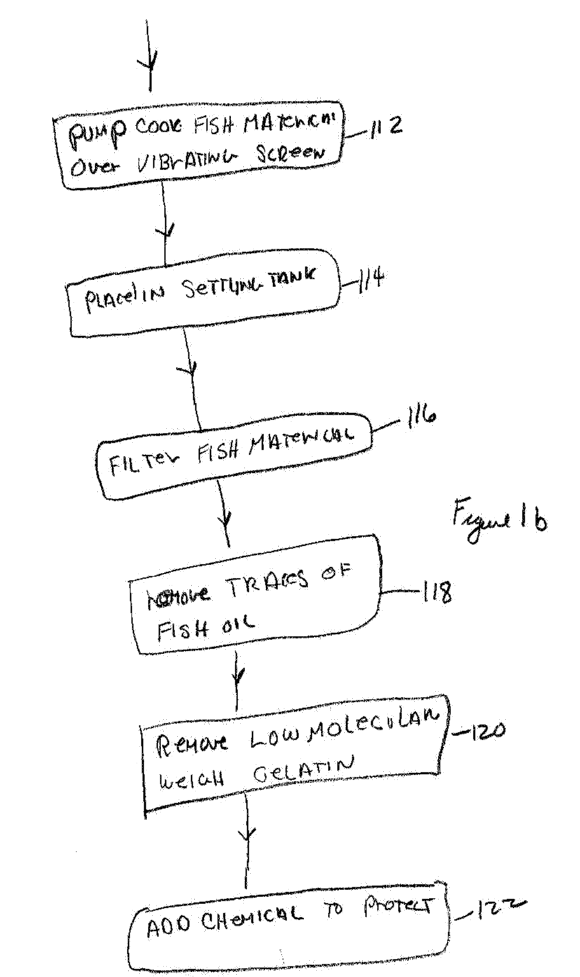

FIGS. 1a and 1b illustrates the method steps of the present invention.

### DETAILED DESCRIPTION

The fish fillets obtained after heading and evisceration are cut up and peeled by hand or machine to leave the fillets on one side and the skins on the other.

The method of the present invention is used to extract gelatin from either wet or dry fish waste, which may include skins, heads and frames, or any other suitable fish wastes. One advantage of the present invention is that the gelatin can be expected in a relatively short amount of time which can be measured from the time the feed material enters the process to the finished product. This short amount of time can be a short as five hours.

In step 102, an enzyme inactivation chemical can be added to the raw fish waste in order to keep the gelatin of the feed material from de-grading. For example, if the transportation trip is longer than approximately 30 minutes, this step is advisable. The enzyme inactivation chemical may include dry calcium hydroxide hydrate in the approximate amounts of 12.5 pounds to 15 pounds per hundred pounds of water in which the fish waste is going to be immersed. Additionally, ice can be added to the above mixture to keep the temperature of the mixture no higher than approximately 5° C. The ice should be added to the mixture before the fish waste is added to the mixture. The mixture of ice and calcium hydroxide hydrate solution tends to draw the blood out of the fish waste and into the solution where the blood can be easily and faster removed at the gelatin processing facility, inactivates the enzymes, and extracts the fats and also dissolves some skin protein that is not gelatin.

In step 104, a rotary screen with optional spray nozzles on the inside and outside of the screen wash the extracted blood and the un-reacted calcium hydroxide hydrate from the fish feed material in approximately 30 minutes after the fish feed material has entered the processing facility. The rotary screen may be supplied with either coldwater or water that can be temperature controlled so as to melt any remaining ice which has not melted with the wet fish feed material.

In step 106, the washed feed fish material is transferred for example by pumping to a preheated, acidified solution which may be water or other suitable material to start the gelatin extraction process. The solution is preheated to approximately 100 Fahrenheit to approximately 170 Fahrenheit in accordance with the type of gelatin that will be extracted and the solution has been pre-acidified to the of range approximately of 1.5 pH to 5.5 pH in accordance with the type the gelatin that will be extracted as shown in step 108.

In order to minimize the gelatin extraction time, the ratio of the hot acidified solution and the fish feed material is approximately 2:1 to 3:1 (solution to fish waste) on a weight basis. In step 110, the fish feed material is placed in the solution in the gelatin extraction tank. The gelatin extraction time preferably does not exceed two hours in duration in order to keep the entire processing time under five hours.

The heated fish feed material and extracted gelatin is pretreated by being filtering so that the untreated or un-reacted fish material is removed before the gelatin clarification process is begun. The filtering in step 112 may be achieved by pumping the fish feed material and extracting the gelatin over a vibrating screen. The hot gelatin solution is transferred to a settling tank in step 114, for example by pumping the hot gelatin solution. At this point, the gelatin extraction tank is available for additional fish material.

The settling tank allows most of the fish oil to rise to the surface where the fish oil is drained off. This process continues until the liquid level approaches the bottom of the tank, and a sight glass aids in this determination.

In step 116, the liquid gelatin solution is filtered to a high clarity for example the liquid gelatin solution may be filtered so that the liquid gelatin solution is approximately 98% transmittance. A plate and frame filter press or a rotary drum vacuum filter may be used to filter the liquid gelatin solution. Additionally, diatomaceous earths may be used in conjunction with the filtering to remove the fine fish material particulates.

In step 118, the remaining traces of fish oil may be removed from the gelatin by incorporating a cellulosic material that absorbs fish oil. This eliminates the need to centrifuge the gelatin to remove the fish oil. The cellulosic material can remove up to approximately 100 percent of the fish oil while a centrifuge can remove approximately 90% of the fish oil. This requires multiple stages of centrifuging.

In step 120, the low molecular weight gelatin is removed from the bulk of the liquid gelatin solution by use of the filter. One filter may be used is an ultrafilter membrane system that has a range of 10,000 to 70,000 molecular weight cut off. This system allows the cut off to be varied and can be changed for different types of gelatin manufactured. The low molecular weight gelatin which has been extracted from the liquid gelatin solution can be used in low high gel strength gelatin products such as liquid protein for beverages and other uses.

In step 122, the concentrated liquid gelatin solution is protected from attack and growth of bacteria, mold or yeast by incorporating a chemical that inhibits this type of growth or it is heat treated to pasteurized the gelatin.

The finished product of concentrated liquid gelatin can be sold as a liquid to customers or dried into a powder or granular form.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. Process for the preparation of gelatin from fish parts, comprising the steps of:
a) washing the fish parts with an aqueous solution of a calcium hydroxide hydrate and ice to remove blood from the fish parts;
b) treating the washed skins with an acid; and then
c) extracting gelatin from the fish skins at a temperature approximately between 100 Fahrenheit to 170 Fahrenheit and at an acidic pH approximately between pH 1.5 to pH 5.5.

2. Process according to claim 1 wherein the method includes adding an enzyme inactivation chemical to said fish parts.

3. Process according to claim 1 wherein the calcium hydroxide hydrate is added in the approximate amount of 12.5 pounds to 15 pounds per hundred pounds of water.

4. Process according to claim 1, wherein said process includes the step of washing said fish parts with cold water.

5. Process according to claim 4 wherein the step of washing said fish parts includes the step of washing said fish parts with cold water that is temperature controlled.

6. Process according to claim 1, wherein the step of extracting is performed at an acidic solution weight to a fish part weight of between approximately 2:1 to 3:1.

7. Process according to claim 1, wherein said extracting step does not exceed two hours in duration.

8. Process according to claim 1 wherein after said extracting step, the fish parts and extracted gelatin are transported over a vibrating screen.

9. Process according to claim 1 wherein after said extracting step, extracted gelatin is placed in a settling tank to remove impurities.

10. Process according to claim 1 wherein extracted gelatin is filtered to high clarity.

11. Process according to claim 1 wherein gelatin resulting from extraction is treated with diatomaceous earth and then filtered.

12. Process according to claim 1 wherein the fish parts originate from fish with scales and fins.

13. Process according to claim 1 wherein said fish parts are selected from the group consisting of tuna, tilapia, Nile perch, salmon, sole, carp, pollack, hake and mackerel.

14. Process according to claim 1 wherein said fish parts are tropical sole.

15. Process according to claim 1 wherein the fish parts originate from fish without scales.

16. Process according to claim 15 wherein said fish parts are selected from the group consisting of channel catfish, African sea catfish and North African catfish.

17. Process according to claim 1 wherein said fish parts originate from catfish.
